(19) United States
(12) Patent Application Publication
(10) Pub. No.: US 2016/0055299 A1
(43) Pub. Date: Feb. 25, 2016

(54) WORKFLOW CANVAS FOR CLINICAL APPLICATIONS

(71) Applicant: Hill-Rom Services, Inc., Batesville, IN (US)

(72) Inventor: Brian Eric Yarnell, New York, NY (US)

(21) Appl. No.: 14/177,851

(22) Filed: Feb. 11, 2014

Related U.S. Application Data
(60) Provisional application No. 61/765,176, filed on Feb. 15, 2013.

(51) Int. Cl. G06F 19/00

(52) U.S. Cl. CPC G06F 19/322

(57) ABSTRACT

A graphical user interface is used to design hospital patient request response protocols—wherein information and messages are provided on patient and provider devices responsive to patient and provider inputs to those devices. A protocol designer interacting with the graphical user interface is enabled to bring into a protocol design space tiles representing steps of a hospital patient request response protocol under design. Ones of the tiles represent tools, such as “Assign Owner,” and “Timer” tools. Others represent respective computer systems external to the system on which the protocol itself will execute, such as staff management systems and/or electronic medical record systems. The protocol designer is also enabled to bring into the protocol design space connections that define an order for performing the various steps. The protocol is executed by a workflow engine, the protocol being initiated in response to a request entered on a patient device.

### CROSS-REFERENCE TO RELATED APPLICATIONS

This application claims the priority of provisional application Ser. No. 61/765,176 filed Feb. 15, 2013.

### BACKGROUND

The present invention relates to systems used in hospitals or other clinical settings by which patients convey requests to care providers (nurses, nursing aides, therapists, etc.). Such a system is referred to as a “request conveyance” system. An example of such a system is the Starling™ system provided by Starling Innovations, Inc.

Using, for example, a tablet or other touch-screen device, a patient may initiate a request by touching a button identifying the nature of the request. If the patient is in pain and would like assistance, she will touch a button labeled “Pain.” An appropriate alert is thereby conveyed to a care provider's computer or portable device indicating that patient needs help dealing with pain. By being afforded with visibility into the specific nature of patients' needs, the hospital staff is given the opportunity to respond with specific courses of action (or “workflows”) for each request. For example, if the patient is reporting pain, the message may be conveyed to a nurse's device. If the patient is requesting a beverage, on the other hand, the message may be conveyed to a nursing assistant's device.

The set of computer-implemented steps carried out by the request conveyance system—either automatically or in response to user input—in support of a given patient request is herein referred to as a “request response protocol” and has aspects beyond a simple conveying of the request. For example, the request response protocol may include a “Notify” function wherein the care provider is prompted to select a screen button which causes the patient to be notified that the patient's message was received. The request response protocol may further include a timing function whereby the care provider is re-alerted as to the patient request if the care provider has not selected a screen option within a predetermined time frame indicating that the care provider has completed the request.

### SUMMARY

Request conveyance systems as just described provide a more sophisticated approach to addressing patient needs than, for example, a generalized alarm as in the case of a traditional nurse call system. We have recognized, however, that further improvements are desirable and possible.

In particular, the request response protocols that are defined in known request conveyance systems are typically hard-coded with limited flexibility or parameterization options. They may enable certain administrative users to select a default “owner”—that is, a particular care provider whose task it will be to fulfill a particular type request—but little, if anything, else. This means that creating or modifying complex request response protocols is time-consuming and expensive, and involves the installation of software updates. We have recognized that it would be desirable for non-technical personnel to be able to define and modify request response protocols as may befit their needs in an easy and convenient manner.

In accordance with the invention, a request conveyance system includes a software solution, or application, that provides a graphical user interface—referred to herein as a “workflow canvas”—and associated administrative tools, via which administrators or other personnel who may not have technical expertise can design and deploy complex, multi-step clinical request response protocols. Specifically, a protocol designer is given the opportunity to assemble on a screen a collection of “protocol elements”—which are graphical representations of, inter alia, actions and connections between and among the actions—in order to define a particular request response protocol that is instantiated in response to patient action, such as touching a button on a touch screen.

In accordance with a feature of the invention, a request response protocol can itself be a protocol element. That is, a stand-alone request response protocol can be an part of another stand-alone request response protocol. For example the request response protocol instantiated when a patient requests her medication might automatically instantiate the very same request response protocol that is instantiated when the patient is asking just for water. This would be advantageous if, for example, the hospital protocol is that a nurse is to bring medications but a nursing aide is always the one to bring water to the patient—whether in the medications scenario or in the case where the patient is asking for water alone.

### DRAWINGS

FIG. 1 shows an arrangement within which a request conveyance system is implemented;

FIGS. 2-5 are illustrations of screens presented to a patient by the request conveyance system,

FIGS. 6 and 7 are illustrations of screens presented to a care provider by the request conveyance system;

FIGS. 8-13 are illustrations of screens presented to a protocol designer designing a request response protocol in accordance with the principles of the present invention;

FIG. 14 shows illustrative hardware and software components that implement the workflow canvas and execute the patient request protocols;

FIGS. 15 and 16a-c are illustrations of “tile property” screens presented to the protocol designer in the course of the designing of a request response protocol.

### DETAILED DESCRIPTION

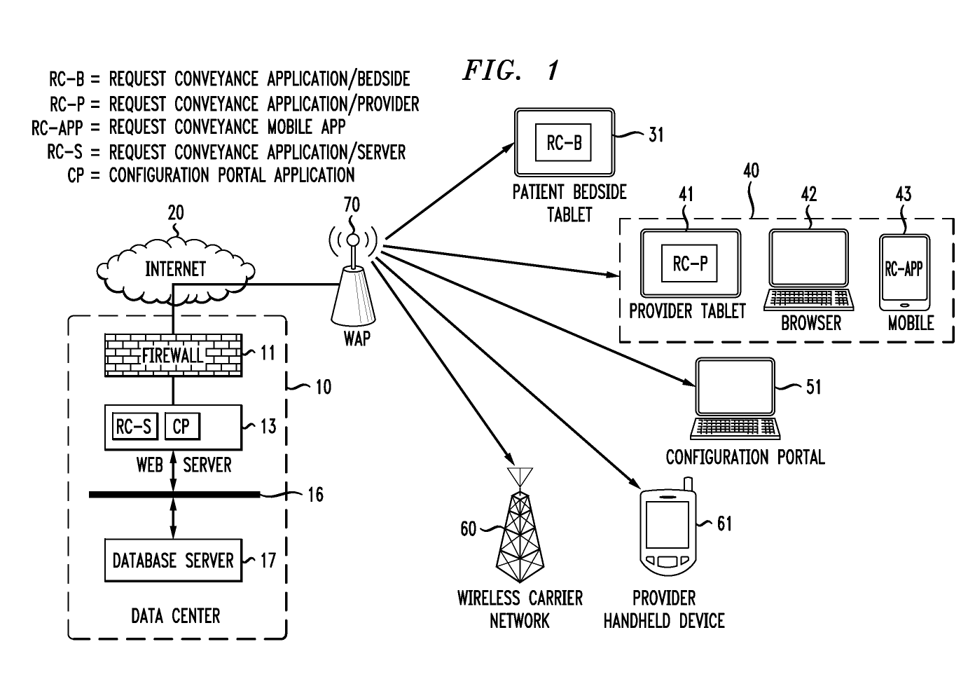

FIG. 1 shows an arrangement within which a request conveyance system is implemented. The request conveyance system comprises applications and other software in combination with various hardware elements that execute the software. Some or all of those same hardware elements may be parts of other systems by virtue of being operable under the control of software implementing those other systems.

The request conveyance system includes a data center 10 and end-user devices of various types illustratively owned by a hospital (or other health care facility) or by care providers associated with the hospital. Only one device of each type is shown in the FIG. as a representative of many such devices. In the embodiment of FIG. 1, data center 10 is remote from the hospital and communication between the data center and the hospital is via the internet. Alternatively, the data center may reside on hospital premises and communication may, again, be via the internet or may be via a local area network.

The end-user devices include patient bedside devices in the form of portable tablets 31. These are illustratively off-the-shelf deviceshaving installed therein a touch screen application designated RC-B (Request Conveyance/Bedside). A hospital patient interacts with screens presented by the RC-B application to interact with counterpart software in the data center designated RC-S (Request Conveyance/Server). These software elements enable the patients to convey requests for care providers (nurses, nursing aides, therapists, etc.) to the data center and to receive information related to those requests from the data center. Tablets 31 connect wirelessly to a wireless access point (WAP) 70 which is connected to the internet, thus enabling communication between the patient bedside tablets 31 and data center 10. Alternatively, the tablets could connect to the internet through wired connections and, indeed, it should be understood that wired connections could be used wherever practical or appropriate in substitution for wireless connections shown in the illustrative embodiment. Being general purpose off-the-shelf devices, tablets 31 might have other applications installed thereon, at the option of the hospital, which owns the devices.

Others of the devices are provider devices 40 via which care providers associated with the hospital similarly communicate wirelessly with data center 10 in order to respond to the patient requests and carry out other related tasks. Interfaces 40 illustratively include portable tablets 41, laptops or other keyboard-oriented computers 42 and mobile devices (e.g., “smartphones”) 43. A touch screen application designated RC-P (Request Conveyance/Provider) is installed in the portable tablets 41 and is used by their respective care providers to interact with the counterpart RC-S software installed in the data center. (The applications RC-B and RC-P illustratively comprise the same actual program code but are provisioned to carry out either the bedside tablet functionality or the provider tablet functionality, the latter functionality being invoked when, for example, a care provider enters login credentials. That program code corresponds to patient/provider interface 173 shown in FIG. 14 as discussed below.) Care providers using a laptop or other computer 42 interact with the data center software via the computer's browser, with the browser screens as transmitted from the data center being essentially the same screens that are displayed on the tablet devices 41 as described hereinbelow. A mobile “app” RC-App installed in the mobile devices 43 enables care provider communication with the data center via a user interface that provides much of the same functionality as described herein as the portable tablets albeit with the displayed information and buttons being adapted for presentation on mobile devices' smaller screens.

As with tablets 31, the provider devices 40 are general purpose off-the-shelf devices which might have other applications installed thereon, particularly in the case of the mobile devices which may be personally owned by their respective care providers rather than being owned by the hospital.

Another device is the configuration portal 51, which is a general purpose computer. A protocol designer uses configuration portal 51 to access, via a web browser, a web application (shown in FIG. 14 and described therein as the editor user interface 171) used by the protocol designer to design and install in data center 10 request response protocols defining the sequence(s) of actions carried out by the RC-S application in managing the communication of patient requests from bedside tablets 31 to provider devices 40 as well as the resolution of those requests. Configuration portal 51 also illustratively communicates with the data center over the internet.

Certain care providers may simply receive email (SMTP) or text (SMS) messages relating to patient requests, these being conveyed to care providers' cell phones or other handheld devices via the WAP access point 70 or a wireless carrier network 60. These would typically be one-way messages to care providers who are not expected to respond to requests by interacting with the data center as described herein in the case of care providers using interfaces 40. For example, a care provider associated with a handheld device 61 may be a clergyman who is informed that a particular patient would like to speak with him and the clergyman will respond by, for example, telephoning or visiting that patient. Alternative methods of communication may include various third-party systems with which the request response system may interface using such systems' standard or proprietary protocols

Communications between the data center 10 and any of the devices 31, 41-43 and 51 are web-based using the http protocol. To this end, the data center includes a web server 13 that sits behind a firewall 11. The RC-S and CP applications are resident within the web server. Also in the data center is a database 17, which the web server accesses via a direct socket connection indicated as 16. Database server 17 contains, inter alia, the graphical representations of the request response protocols as created by the protocol designer as well as models of the protocols that are used by the RC-S application at run time in order to actually execute the protocols. Not shown are a secondary (backup) web server and database server. It will be appreciated that the presentation of various screens and information on the patient bedside tablets 31 and provider devices 40, although having the “feel” of communications between those devices directly, is actually the result of the RC-S software responding to information from the devices and transmitting information to those devices to cause the various screen views to be presented.

Not shown in FIG. 1 are one or more computers whose users are software developers and/or administrators who can log into the data center via the internet to interact with and/or modify the system code.

Although certain types of devices are shown as being the patient bedside devices, care provider devices and so forth, these are merely illustrative. In particular, the patient bedside devices, instead of being tablets owned by the hospital, might be patients' own mobile devices into which an appropriate mobile app has been downloaded to provide the functionality described herein for the patient bedside tablets.

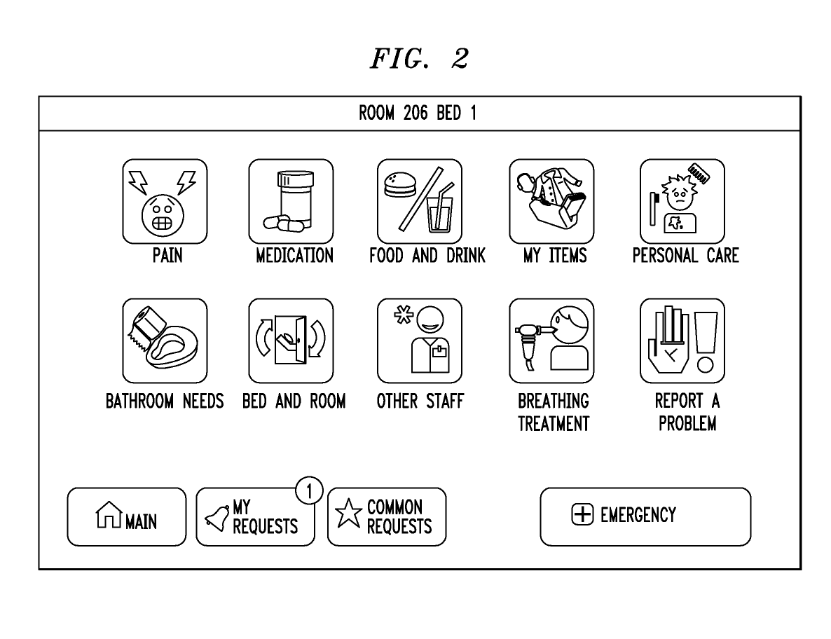

FIGS. 2-5 are illustrations of screens presented to a patient using one of patient bedside tablets 31. The patient is in Room 206 on a particular hospital floor.

The main screen presented to the patient is shown in FIG. 2. Illustratively ten main request buttons are presented via which the patient can communicate her request for assistance from an appropriate care provider by touching one of the buttons. The request will appear on one or more of the provider devices 40 as discussed in further detail below.

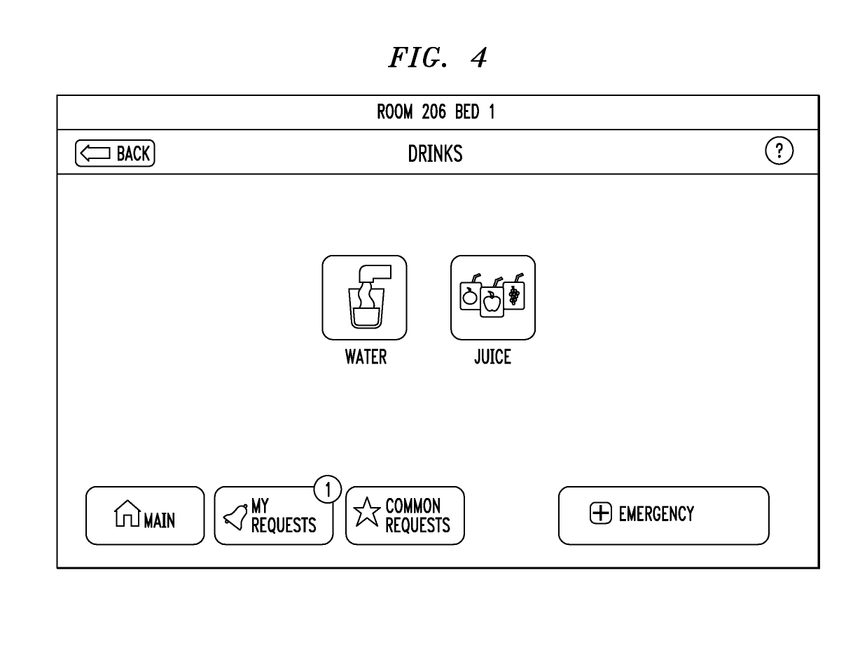

Four buttons at the bottom of the screen appear on every screen that the patient may navigate to. One of these is an “emergency” button which will cause a distinctive “emergency” message and/or sound to by displayed at one or more of the provider devices. A “common requests” button will bring up a screen showing buttons associated with requests that this particular patient has proven to use the most often. These may be one or more of the buttons shown on the main screen and/or buttons that appear on sub-screens (e.g., the “water” button shown in FIG. 4 as described below). A “My Requests” button brings up a screen showing pending requests for this patient, i.e. requests that the patient has made previously which have not been completed by the care provider staff. The numeral “1” in the corner of this button shows that at the moment there is one as-yet-uncompleted request for this patient. And a “Main” button brings up the screen seen in FIG. 2 if the patient has navigated away from that screen.

Although not shown in the FIG., other buttons or menu options might be displayed for the patient. For example, one option might be whether the patient wishes to have an automated voice announce the various button selections as they are made. Another option might allow the patient to select a language for the automated voice announcements and/or button labels in substitution for a default language that was chosen by or for the patient at the time of admission.

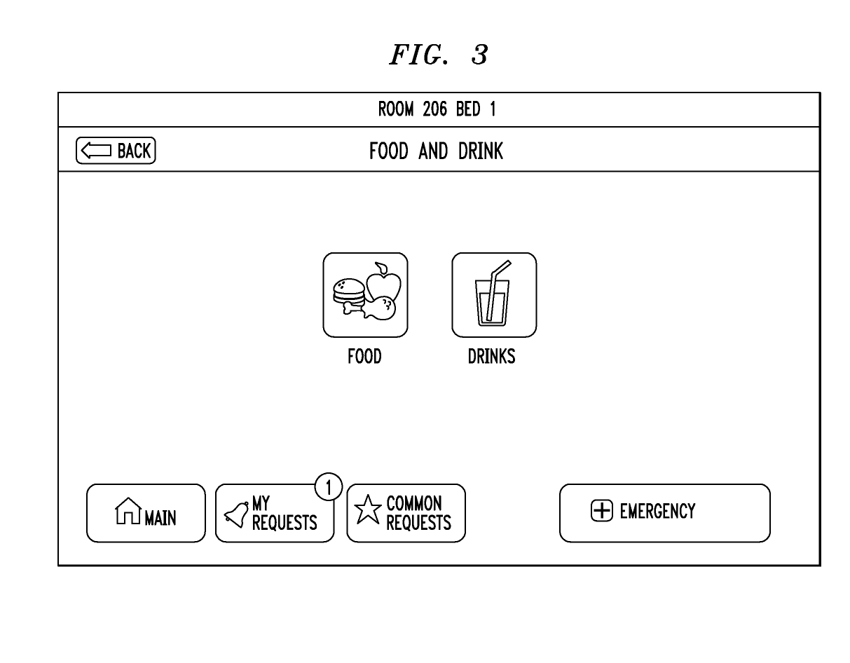

Assume, then, that the patient would like some water. She touches the “Food and Drink” button. This brings up a “Food and Drink” sub-screen, as shown in FIG. 3 at which the patient can choose either a “Food” button or a “Drinks” button. This is a significant choice because a request for food may be routed by the system to a meal kitchen somewhere remote from the patient floor whereas a request for a drink may be routed to a nursing aide on the hospital floor because water and juices can be gotten from a pantry on the patient floor. Since the patient wants water, she will touch the “Drinks” button. This brings up the screen shown in FIG. 4 which offers a choice of Water or Juices. The patient selects the “Water” button and the water request will be forwarded to the provider device of one or more care providers, as explained more fully hereinbelow. If the patient had chosen “Juices,” a further sub-screen would have been brought up showing the available juice choices and then, again, one or care providers would have been notified.

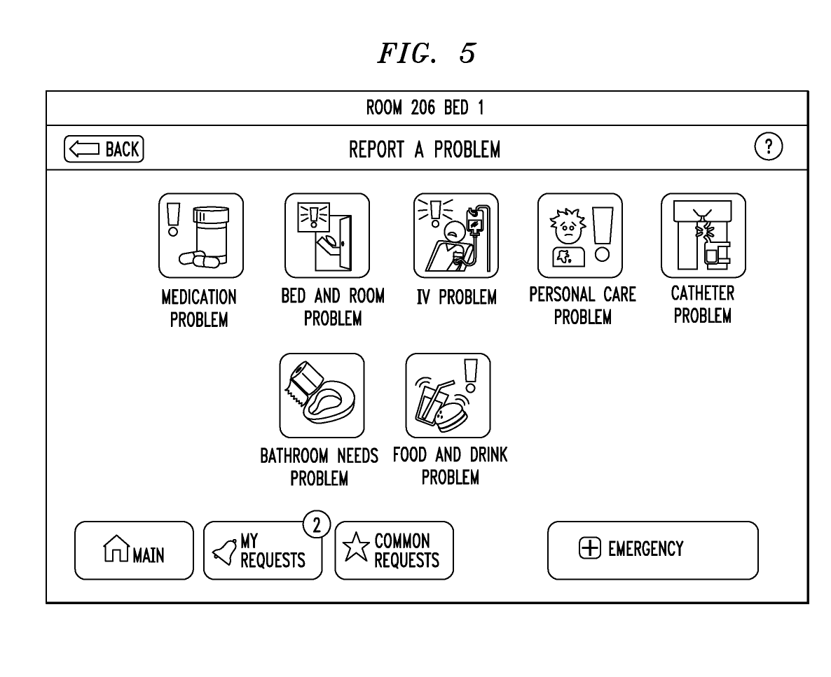

Returning to FIG. 2, assume that the patient is having a problem of some kind and would like assistance. She therefore touches the “Report a Problem” button. This brings up a “Report a Problem” sub-screen as shown in FIG. 5. Here the patient is offered a number of alternatives such as “Medication Problem,” “Bed and Room Problems”, etc. Although not shown in the FIG., an “Other Problem” button might also be one of the choices. Again, a notification would have been sent to one or more of the provider devices 40.

Touching the “Pain” button, as another example, may bring up a sub-screen showing representations of the front and back of a person and the patient is prompted to point to her area of pain, e.g. her stomach. Once she has done so, a further sub-screen may be presented at which the patient is prompted to indicate her level of pain on a scale of 1 to 10, e.g. “8,” after which a care provider is notified of that the patient has reported having, for example, pain in her stomach at pain level “8”.

Touching the “My Items” button brings up a sub-screen from which, for example, a bed-bound the patient can choose a personal item that she would like brought to her from, say, a bedside cabinet that she cannot reach. The sub-screen might list such items as “Glasses” “Cell Phone” “Medication” “Reading” “Toiletries” etc. Touching some of those might bring up further sub-screens.

Assume, however, that the patient has, in fact, touched the “Report a Problem” button and then a particular problem on the screen of FIG. 5. Note that the “My Requests” button as shown in FIG. 5 now has the numeral “2” in the corner, reflecting the fact that there are now two requests pending for this patient—illustratively the request that was pending at the point in time associated with FIG. 2 plus the water request entered as described above. After the patient has touched one of the “problem” buttons shown in FIG. 5, that numeral will advance to “3”, the third pending request being the problem that the patient is now reporting.

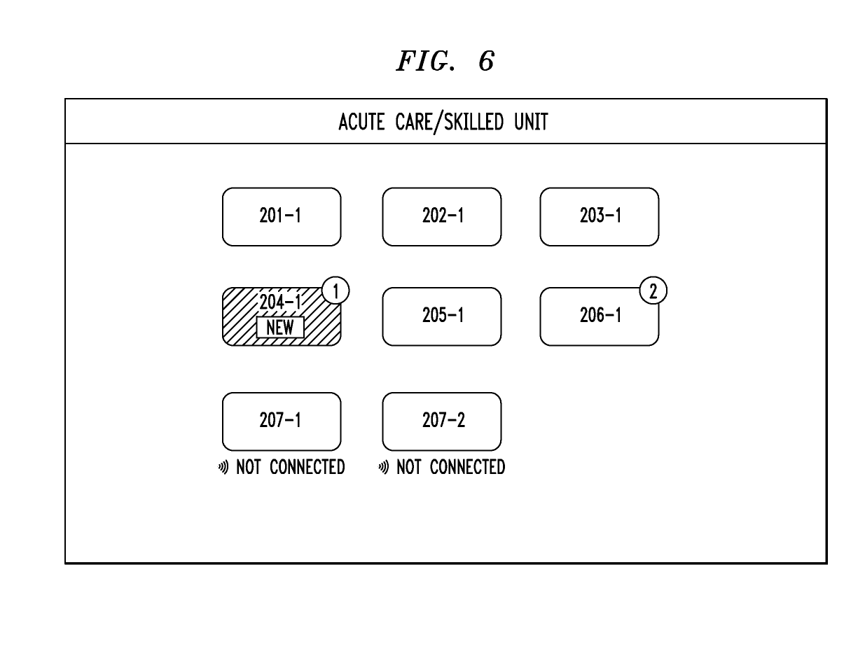

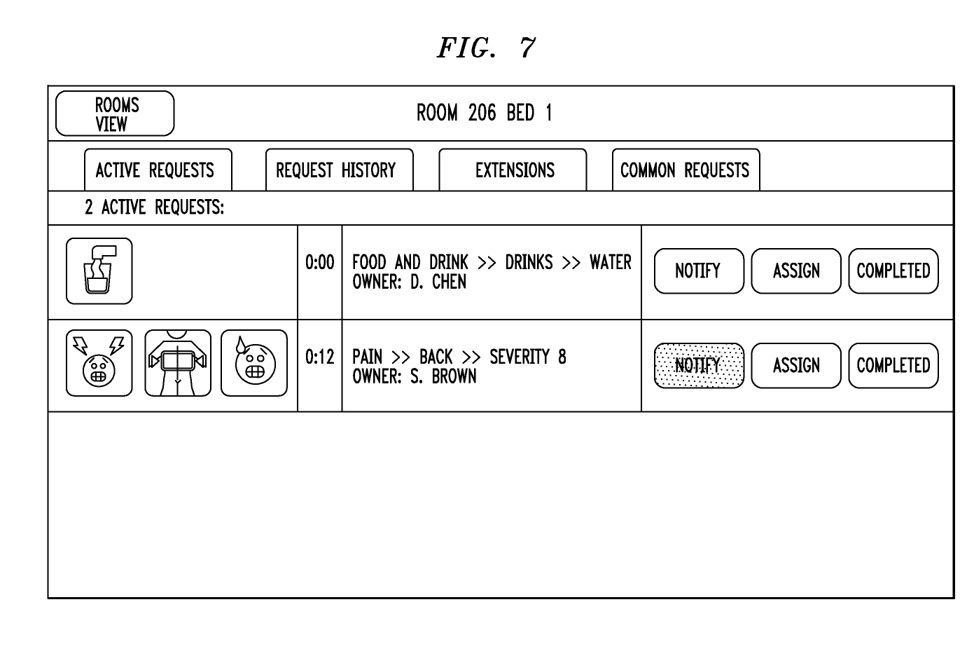

FIGS. 6-7 are illustrations of screens presented to a particular care provider on one of the provider devices 40—specifically on one of the tablets 41 associated with that care provider.

FIG. 6 shows a Rooms View screen which, for certain care providers or other staffers, will be optioned to be the main, or home, screen vis-à-vis the request conveyance system. These will be care providers or staffers who need to be able to see information relevant to all patients within a particular group of patients, e.g., all the patients in a particular hospital unit, whether or not that staffer will be the “owner” of any given request, i.e. the person assigned to respond to the request. A nurse at a particular nursing station might be such a staffer. Other staffers may have other views as their main, or home, screens, as noted in more detail hereinbelow.

The Rooms View screen of FIG. 6, more particularly, displays buttons for seven patient rooms 201 through 207, of which all are single-bed rooms except for room 207, which is a two-bed room. There is a button for each patient, labeled with a room number and a bed number.

Unassigned rooms, or rooms where the patient has not been outfitted with one of patient bedside tablets 31, are designated “not connected,” as seen in this example is the case for rooms 207 and 208.

A number in the corner of a button indicates the number of uncompleted requests associated with the patient in question. Thus there is one uncompleted request for the patient in Room 204. And at the point in time depicted in FIG. 6, the water request from the patient in Room 206 has just been conveyed to this provider device. The color of the associated button has changed, e.g., from something neutral to red, a tone has sounded, the word NEW appears on the button and the “pending request” numeral has just advanced to “2.” The care provider is thus prompted to attend to this new request by selecting the Room 206 button by touching it or clicking on it (if the provider's device is a device without touch-screen capabilities), at which point the button will revert to its original color. If the new request is not attended to within some set period of time, the care provider may be prompted by, for example, an audible reminder. After several such reminders, the request may be given to a new owner.

Once the button for Room 206 has been selected, the screen shown in FIG. 7 is presented on the provider device with an “Active Requests” tab selected. The screen shows all the active, i.e. uncompleted, requests associated with all the eight patient beds represented in FIG. 6. Each line entry also shows the so-called owner of each request, meaning the person that the request response system has assigned to respond to the request by performing the requested task. At the present time there are two active requests, both from the patient in Room 206, Bed 1. The owner of the “Water” request is a nursing aide named D. Chen. A prior request from that patient was for pain relief, the three icons in the first line entry indicating that the patient had selected on successive screens, “pain,” “stomach,” “severity 8 (on a 1-10 scale).” The owner is this request is a nurse S. Brown. The entry “0:12” indicates that this request was entered by the patient 12 minutes ago.

At the same time that the above two requests appeared on the devices whose screens are shown in FIGS. 6 and 7, they were also conveyed to devices associated with the respective owners. These would typically be smaller mobile devices such as smart phones. Thus a person responsible for overseeing then entire seven-room unit is able to see all the requests from patients in those rooms while individual care providers are able to see on their own devices the requests that have been assigned to them.

Associated with each request shown on the screen of FIG. 7 are “Notify” “Assign” and “Completed” buttons. The “Notify” button for the pain relief request was originally the same color as what is seen in FIG. 7 for the “Notify” button associated with the just-received water request. However, S. Brown has already selected the “Notify” button associated with the pain relief request, which caused a message to be displayed on the beside device in Room 206 indicating that the request had been received and that help was on the way. The color of that “Notify” button has been changed. Indeed, it has been “grayed out” meaning that it has been deactivated so that S. Brown will not inadvertently send multiple “help is on the way” notifications responsive to this request. At the point in time depicted, that action has not yet been taken vis-à-vis the just-received water request and so the “Notify” button for the water request is still its original color.

At this time, then D. Chen needs to attend to the patient's “Water” request at first touching the “Notify” button associated with that request. In this example, D. Chen may be standing near the tablet device shown in FIGS. 6 and 7 and can touch the “Notify” button of FIG. 7. Before accepting this as a bona fide input from D. Chen, the system takes steps to ensure that it is really D. Chen who has touched the “Notify button.” This may be accomplished by, for example, prompting the user to supply a password or to perform a card swipe. Other possibilities include biometric identification and/or the use of proximity sensors to verify that the person at the location of the tablet device is, in fact, D. Chen. The process of confirming the identity of users in these or any other way is referred to herein as “validating” that user. Since the request also went to D. Chen's mobile device, she could alternatively enter a “Notify” from that device.

For the most part, only the owner assigned to a request will be allowed to invoke the “Notify” function (or the “Assign” or “Completed” functions discussed below) vis-à-vis that request. The system is provisioned, however, in such a way that selected other providers are enabled to do so, such as the nurse manager responsible for Rooms 201 through 207.

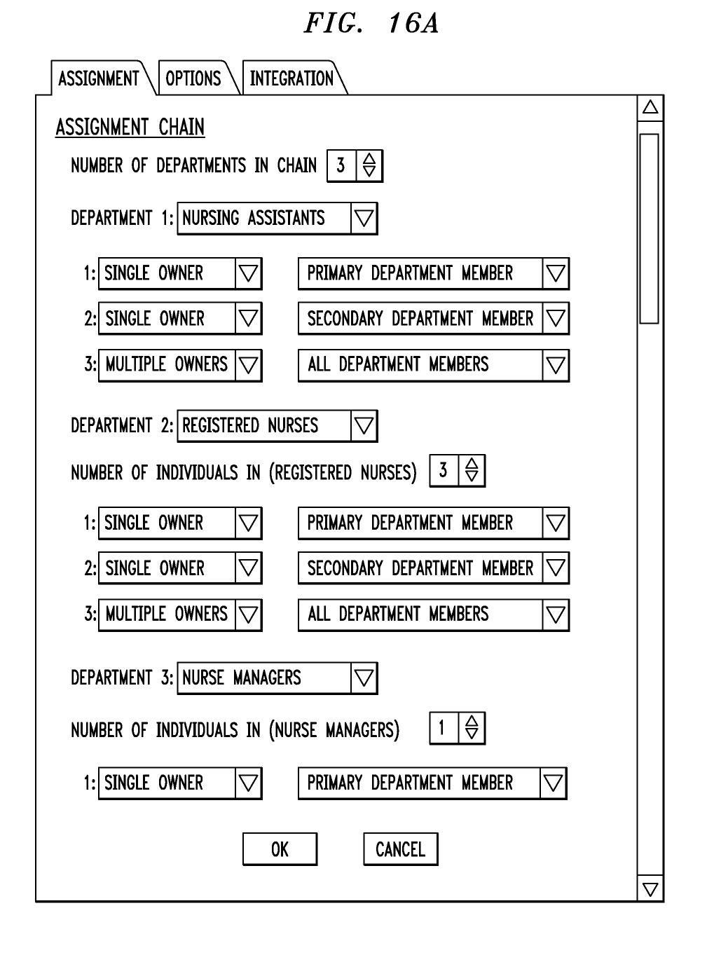

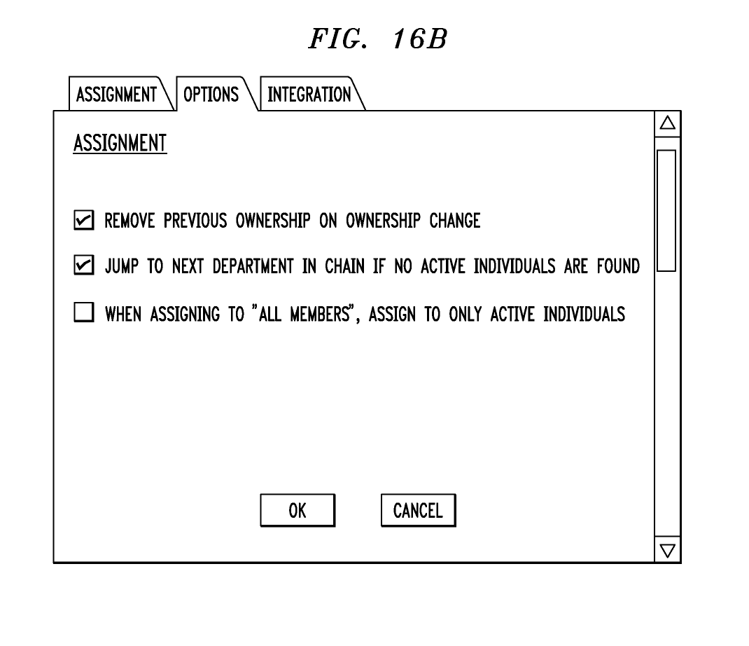

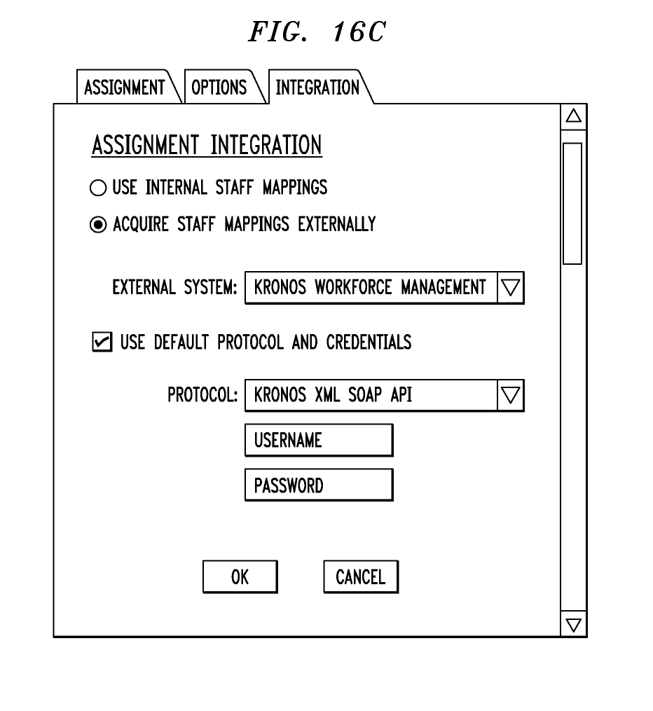

There are several ways in which care providers like D. Chen can be assigned to be the “owner” of a given request, i.e. to be the person tasked with addressing a particular request from a particular patient. One way is that D. Chen is has been identified as the Primary Department Member for that category of request. (This is described in further detail below in connection with FIG. 16a.) Assume that a request for a drink is one of those categories. In that case, the patient's water request went to D. Chen's device immediately upon the patient having entered that request. Another way that a drink request might get conveyed to a staff member is if a request was assigned to another staff member who did not complete the request within a predetermined time, at which point the request conveyance system re-assigned the request to D. Chen and at which point the Rooms View screen becomes as shown in FIG. 6, with Room 206's button having turned red, etc. and with D. Chen having been notified of the request on her mobile device.

Another way that a request might get conveyed to a staff member is by explicit assignment from another staff member. For example, the patient's pain request was originally assigned to some other nurse on the floor, R. Smith. She initially selected the “Notify” button and is intending to visit the patient's room to help her with her pain request but now must attend to a more urgent matter and wants to pass off this request to her colleague S. Brown. In that case the original owner nurse R. Smith would have selected the “assign” button appearing on, for example, the tablet at the nurses' station or on her mobile device corresponding to this patient's request. After the system has validated the user as being R. Smith, the system would have presented to her a list of available alternative assignees from which R. Smith chose S. Brown. The request may still remain on R. Smith's Active Request list—although now showing S. Brown as the owner—or it may disappear therefrom, depending on whether a certain option was selected as discussed below in connection with FIG. 16b. As an alternative to having R. Smith identifying an alternative assignee, the system may allow her to identify a department from which an owner is to be selected by the system based on information that would have been input to the system via the screen of FIG. 16a

Once a care provider has fully attended to a request, she will select the “Completed” button for that request. Once the owner has been validated, the patient may, in some embodiments, be is notified on her patient bedside tablet that—at least as far the staff is concerned—the request has been fully attended to. In addition, the entry for the request will thereupon be moved from the “Active Requests” tab screen to the “Request History” tab screen, at which a history of the Room 206 patient's requests can be viewed. A “Request History” is also viewable on individual providers' mobile devices showing the history of requests that were completed by that particular provider. The “pending request” numeral on the care provider's Rooms View screen (FIG.6) will decrement. The pending requests numeral at the patient's “My Requests” button will likewise decrement and the completed request will no longer appear on the patient's “My Requests” screen upon the patient selecting that button.

Other tabs on the FIG. 7 screen are “Exclusions” and “Common Requests.” The screen for the “Exclusions” tab provides information about requests that should not be fulfilled. For example, a patient scheduled for surgery may be excluded from any food or drink for some period of time prior to the surgery. Part of a staffer's workflow would be to consult this tab before fulfilling any request that might be so excluded. In particular embodiments, a request for which an exclusion has been entered might be automatically flagged as such on the Active Requests tab screen. The “Common Requests” tab shows a single line entry for each type of request entered by a patient in the past, along with a number indicating how many times that request was made over some time period.

It will be appreciated that a screen like that of FIG. 7 can be viewed for any patient at any time simply by selecting the appropriate button on the Rooms View screen, whether or not a new request has been received.

It was noted above that certain care providers may have something other than a Rooms Views as their main, or home, screens. An alternative main, or home, screen could be a list of currently active requests across some patient population. An example of this is an inhalation therapist whose provider device is not a tablet but a mobile device. The inhalation therapist's main screen lists the currently active requests for inhalation therapy from a particular population of patients that might well be much larger than the population of a given nursing unit. The app that provides the inhalation therapist's interface to the request conveyance system will provide some or all of the same functionalities described above in connection with FIG. 7.

More generally, some or all of the screen views or small-screen-formatted versions thereof—that are displayable on the tablet device illustrated for FIGS. 6 and 7 are also displayable on individual providers' mobile devices.

The scenarios represented by the screen views of FIGS. 2-7 belie a more complex request response protocol, by which is meant a set of computer-implemented steps carried out either automatically or in response to user input. For example, a timer must be set in order for the system to take action if an assigned owner has not completed a task within a set time. Indeed, at some point during the creation of the request response protocol, someone had to decide what the timer's time interval would be—something that will vary in accordance with the urgency of a request. (A request for inhalation therapy (e.g., for an asthma patient), for example, requires a much shorter response time than a patient's request for his bed pan to be emptied.) As another example, it may be desired to send the patient a mini-survey at some selected time after the “Completed” button is selected asking the patient if the patient's needs have been met. Additionally, certain behind-the-scenes actions might need to be taken. For example, it would be desirable for after a medication has been administered for the request conveyance system to automatically interface with a hospital's electronic medical record system to enter a record of that medication administration.

It is straightforward from a programming perspective to “hard code” a desired request response protocol into the request conveyance system's RC-S program code. It is also straightforward from a programming perspective to change the code later in order to make changes in the protocol.

In accordance with the present invention, however, we have recognized that improvements can be made in order to cut down on the time and effort required to implement a change in a request response protocol and in order to allow non-technical staff to define and/or a protocol.

In accordance with the invention, a request conveyance system includes a software solution, or application, that provides a graphical user interface—referred to herein as a “workflow canvas”—and associated administrative tools, via which administrators or other personnel who may not have technical expertise can design and deploy complex, multi-step request response protocols.

Specifically, a protocol designer is given the opportunity to assemble on a screen a collection of “protocol elements” that include, inter alia, actions and connections between and among the actions, in order to define a particular request response protocol that is instantiated in response to patient action, such as touching a corresponding button on a touch screen.

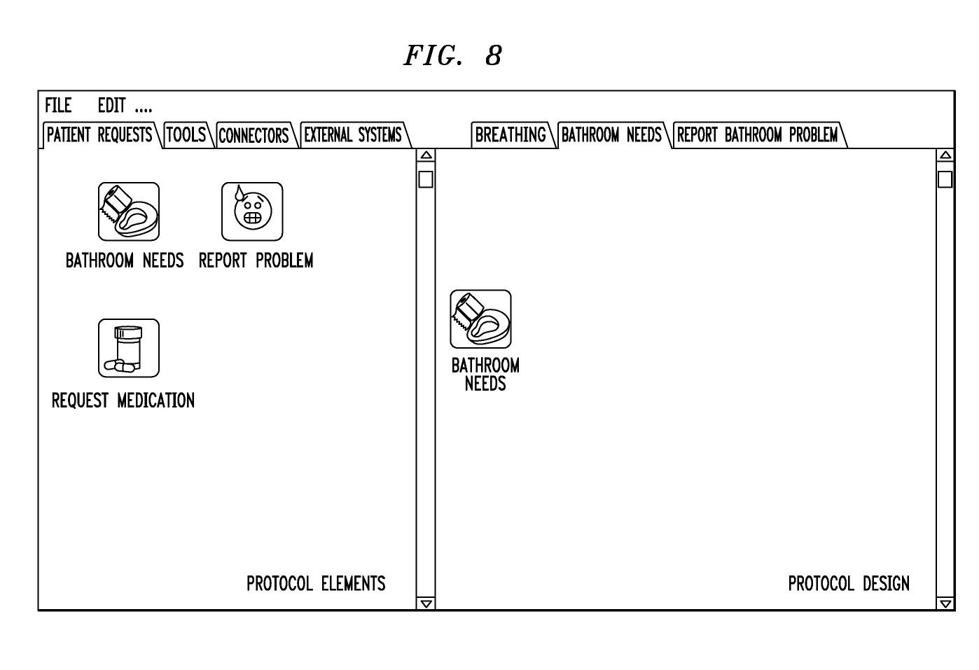

FIGS. 8-13 show screens illustrating how a screen would appear to a protocol designer in the course of using the workflow canvas to design a particular request response protocol—in this case it is a “bathroom needs” protocol corresponding to the “Bathroom Needs” button of FIG. 2.

The workflow canvas user interface comprises a menu area, a protocol element pane and a protocol design space. The menu area includes a set of conventional menu items across the top such as “file,” “edit” and so forth, with drop-down menus appearing when a menu item is selected. The protocol element pane includes four protocol elements tabs each corresponding to one of four categories of protocol elements to be described shortly. Selecting a particular one of those tabs causes icons, or in some cases “tiles,” for protocol elements in the different categories to appear within the pane. The protocol design space is a section into which tiles from the protocol element pane can be placed—either via, for example, a “copy and paste” or a “drag and drop” operation—in order to construct a given request response protocol.

By looking at the protocol element pane in each of FIGS. 8-11, for example, one can see illustrative representations for each of the four categories of protocol elements manipulatable by the protocol designer within the protocol design space, the categories being as follows:
patient requests, represented as tiles, which are the potential requests that a patient can generate on-demand, such as “Drink,” or that, in accordance with a feature of the present invention, that the system might generate on the patient's behalf automatically in the course of executing a request response protocol;
tools, represented as tiles, which define specific actions during the protocol, such as sending a notification;
connections, represented as arrowed lines, which are of two sub-types:
   logical connections, which define the logical flow among the tools or other protocol elements, based on, in some cases, whether a current protocol element has a state of success of failure;
   data connections, which point to external data sources for protocol elements to interact with;
external systems, represented as tiles, which are configurable integrations of the request conveyance system into other systems, such as a hospital's electronic medical record (EMR) system, patient admission/discharge/transfer system or staff management system.

Starting, then with FIG. 8, this FIG. shows the workflow canvas user interface screen at a point in time after a protocol designer has selected a menu item that enables her to define a new request response protocol. The “patient requests” tab was already the one shown “on top” to reveal tiles for each of a plurality of patient requests that the request conveyance system designer has determined will be definable for the request conveyance system. Only three such tiles are shown but there will, of course, be many more, which can be brought into view via a scroll bar associated with the protocol elements pane. A list of supported patient requests might also be viewable in a textual list accessed via a menu.

The protocol designer has decided to create a request response protocol for the patient request, “Bathroom Needs” and has thus placed a copy of the “Bathroom Needs” tile into the protocol design space. The protocol designer has also entered the request response protocol name “Bathroom Needs” in a tab which initially was displayed with a blank legend when the protocol designer had selected a menu item to indicate that she wanted to design a new request response protocol. It can be seen that the protocol designer has also already designed two other request response protocols each having a respective tab associated with the protocol design space—namely a “Breathing” protocol and a “Report Bathroom” protocol. These tab labels need not be the formal names that the system uses for Patient Requests and/or as button labels (e.g. “Breathing Treatment” and “Bathroom Needs Problem”) because these tab labels are only ever seen by the protocol designer and she can, therefore, label them however she wishes.

It is desirable that user-selected ones of the request response protocols be able to be brought into view via tabs as shown in FIGS. 8-13 because a protocol designer may want to be working with more than one at once and/or to be cloning or copying-and-pasting all or portions of various protocols into other protocols being designed. In a typical embodiment, there will be too many request response protocols overall to have the tabbing arrangement shown in the FIGS. be the only way for the user to access the various protocols. Although not shown in the FIGS. it is envisioned that the user might be provided with a way of selecting particular already-designed protocols from a menu or sequence of menus and to have the selected protocols appear in respective tabbed views as seen in these FIGS.

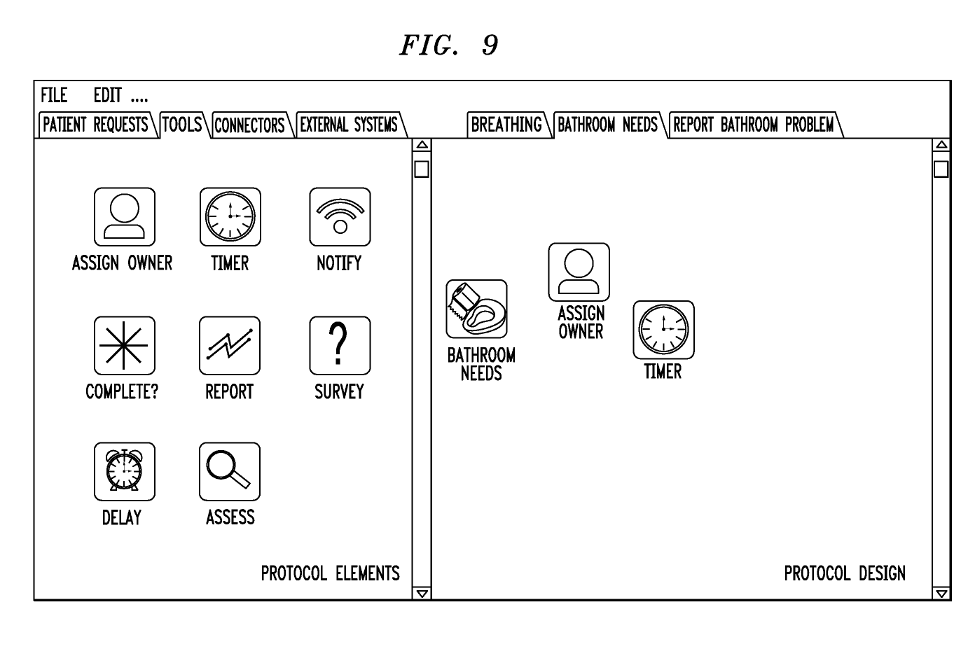

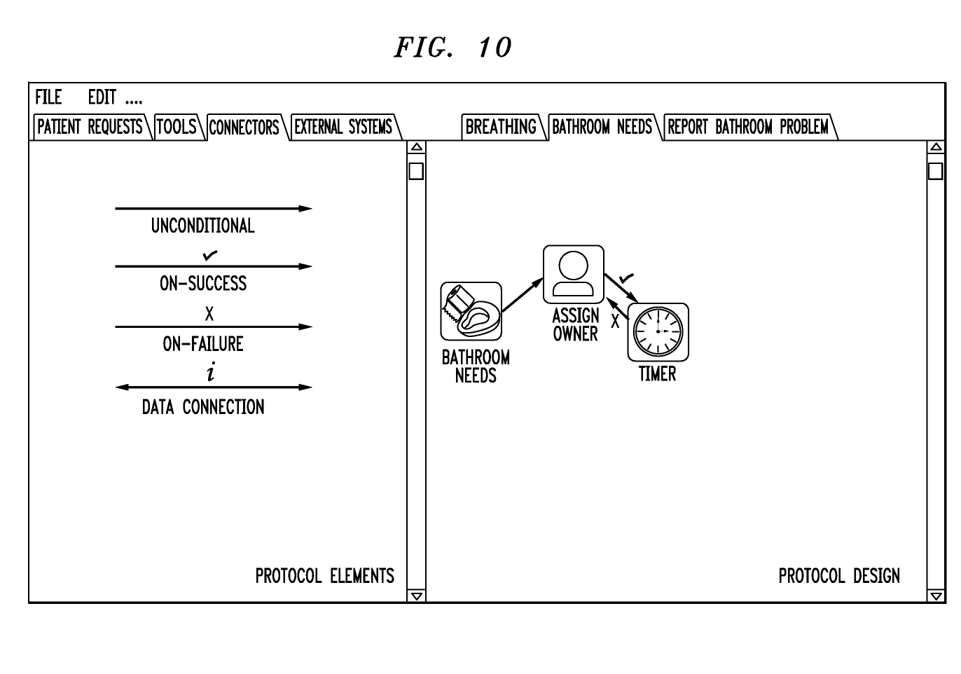

The protocol designer now selects the “Tools” tab, resulting in the presentation within the protocol elements pane of a number of tools that can be included within the request response protocol being constructed, as shown in FIG. 9. It is specifically seen in FIG. 9 that the protocol designer has placed “Assign Owner” and “Timer” tools into the protocol design space. The tools are sometimes referred to herein as “steps” inasmuch as they can be understood as corresponding to particular steps that are performed at run time when the protocol executes in response to a particular patient request.

More generally, the screen representation of the eight tools—alternatively sometimes referred to herein as “tiles”—are illustratively made available to the protocol designer, as follows:
“Assign Owner”—by which an owner is assigned to attend to the patient's request;
“Timer”—which pauses the execution of the request response protocol until either some event occurs or a selectable period of time has expired;
“Notify”—which causes a notification to be sent to a care provider to indicate that a prior activity or action has happened, e.g., that the care provider has been assigned to be the owner of the request;
“Complete”—which is essentially a wait state for the request response protocol, waiting for the owner to select the “Complete” button to indicate a completion of the requested task;
“Report”—which invokes automatic access to a system external to the request conveyance system, such as an electronic medical record system;
“Survey”—which causes a survey to be presented to the patient, typically asking the patient if the request was fully fulfilled in the patient's view;
“Delay”—another wait state of a selectable duration; and
“Assess”—a routine by which the patient's answers to a survey are analyzed and, based on the results of the analysis, further actions may be launched.

In other embodiments, the “Timer” and “Delay” functions might be implementable by a single tool that is configured to provide the desired functionality by the protocol designer on tile property screen discussed below.

Each instantiation of at least some of the tools into the protocol design space potentially requires the inputting of configuration parameters by the protocol designer. For example, the “Assign Owner” tool needs to be configured with information about which staff member is to be assigned as the owner for the task at hand and where information about the staff is to be found; the “Timer” tool needs to be configured with the time period that the timer is to time; the “Survey” tool needs to be configured with information indicating what the patient is to be asked in the survey and what constitutes a “success” and what constitute a “failure” of the survey process. These configuration inputs for a given instantiation of a tool in the protocol design space are illustratively input by the protocol designer by “right-clicking” on the tile in question and then inputting information into screens that pop up at that time. These are referred to herein as “tile property” screens. Examples of this are discussed below in connection with the “tile property” screens shown in FIGS. 15 and 6a-c.

Looking again at FIG. 9, it is seen that the protocol designer has brought the “Assign Owner” tool into the protocol design space because the first thing she will want to happen after the patient has selected the “Bathroom Needs” button is to have an initial owner assigned to the request. She has also brought the “Timer” tool into the protocol design space because a new owner will have to be assigned if the currently assigned owner has not indicated completion of the request within a selected time associated with that request and the “Timer” tool, if it times out, will re-initiate the “Assign Owner” functionality.

A logical flow of operations among the tools—that is, an overall order of the execution of the various steps—needs also to be defined. To this end, as shown in FIG. 10, the protocol designer has now selected the Connectors tab and can place any of three logical connectors into the protocol design space. Once brought into the protocol design space, the non-arrowed “from” end and the arrowed “to” end of a connector can be “grabbed” via the computer mouse and the connector can be “stretched” to put its endpoints on the tools that it is connecting.

The three types of logical connectors are “unconditional,” “on-success,” and “on-failure” connectors. (The fourth, “data connection” connector is used in a manner discussed hereinbelow.) Specifically, the “unconditional” connector is used when the protocol is always to proceed to a tool immediately after a previous tool in the protocol has completed its operation. The “on-success” connector is used to bring the protocol to a particular tool if the previous tool's operation was successful as defined by the software designer who designed the tool. For example, “success” for the “Survey” tool would usually mean that a user has answered at least one question and selected an “enter” button. “ For the “Assess” tool, “success” may mean that the patient indicated satisfaction with the owner's response to her request. And the “on failure” connector is used to bring the protocol to a particular tool if the previous tool's operation failed as defined by the software designer who designed the tool. For the “Assess” tool, for example, “failure” may mean that the patient answered at least one survey question with a “dissatisfied” indication.

An alternative to having a separate tab for connectors might be to have an always-present add-a-connector button displayed on the screen. In response to a protocol designer clicking on that button, a connector would appear in the protocol design space and a pop-up screen would prompt for an indication as to what type of connector this should be. As before, the two ends of the connector would be able to be “grabbed” and moved to desired positions to connect two tiles.

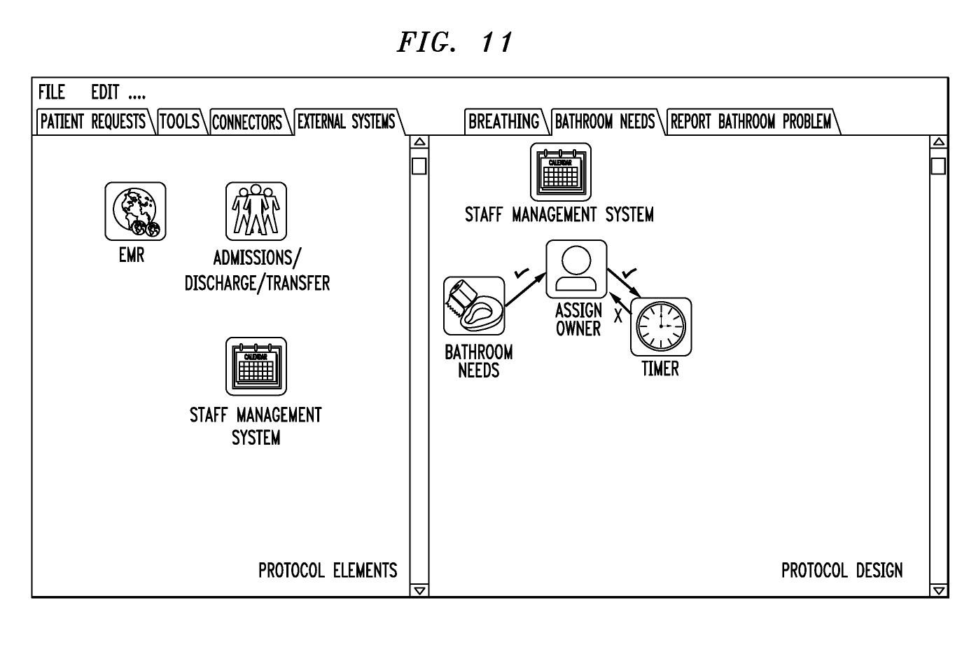

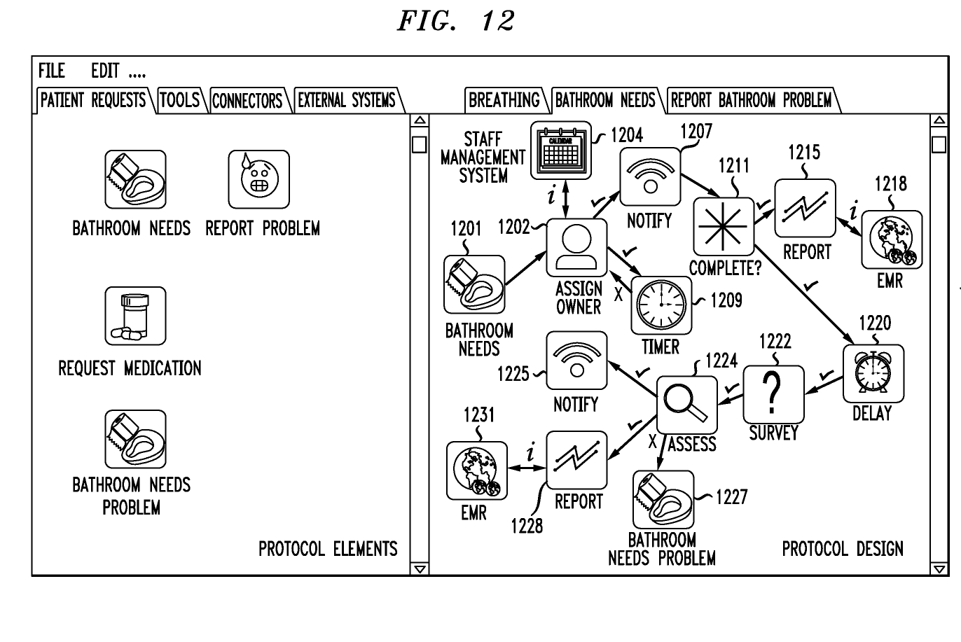

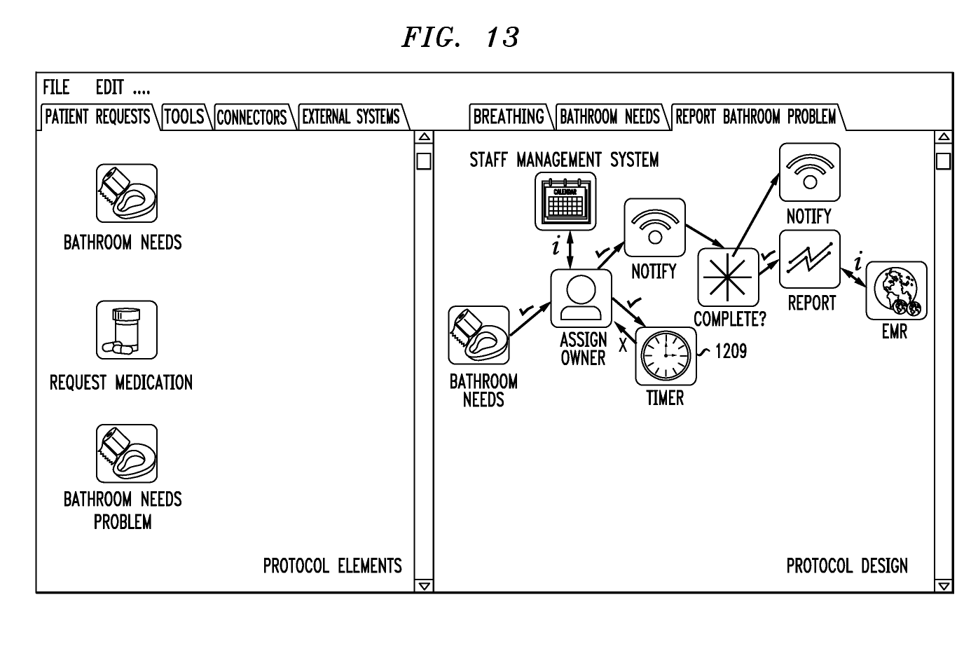

As shown in FIG. 11, the protocol designer has now selected the “External Systems” tab which illustratively provides three external system tiles; one for an electronic medical record (EMR) system; one for an admission/discharge/transfer computer system; and one for a staff management system. The protocol designer may need, or desire, to include in the protocol an interfacing with one or more of these external systems (“external” meaning external to the request conveyance system although they may well be “internal” to the hospital). As shown in FIG. 11, a “Staff Management System” tile has been brought into the protocol design space because when the protocol executes, the “Assign Owner” tool needs to be able to access the hospital's staff management system in order to identify as the owner for the patient's request a staffer who has the right job title for the task (as defined by the workforce designer via a data input screen associated with the “Assign Owner” tool) and who is actually then at work and available (i.e. not having called in sick and not on a meal break.) These tiles represent configurable “behind the scenes” integrations of the request conveyance system with the external systems, with the configuration data being supplied via one or more “tile property” screens as described below in connection with and FIG. 15 in connection with the “Staff Management System” tile and FIGS. 16a-c in the case of the “Assign Owner” tile.

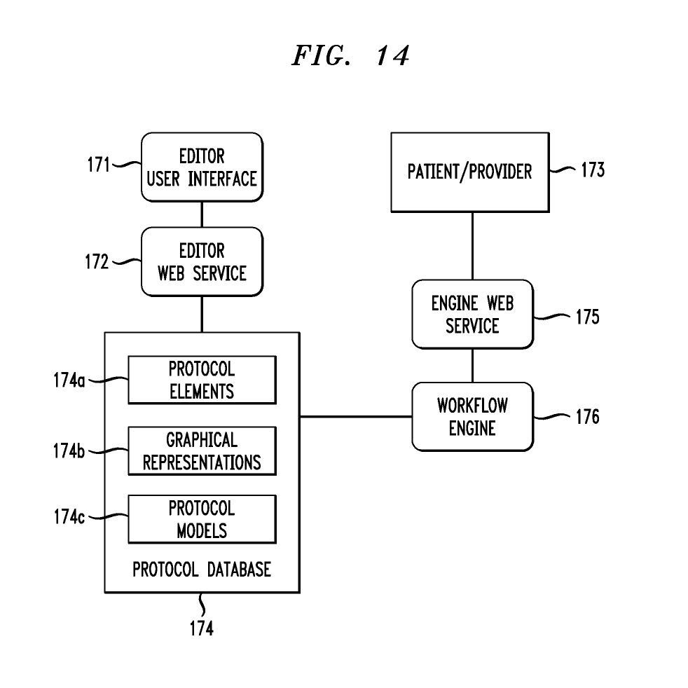

FIG. 12 shows the what screen looks like after the protocol designer has completed her design for the “Bathroom Needs” request. With quick reference back to FIG. 11, it may be noted that at some point during the design process, the protocol designer had returned to the Connectors tab and brought a “data connection” connector into the protocol design space to indicate that when the protocol reaches the “Assign Owner” step, it should obtain its needed staff information by accessing the staff management system that the protocol designer had associated with the “Staff Management System” tile on the screen per FIG. 16c. It is seen that the protocol designer has most recently selected the “Patient Request” tab. This was done for a reason described below.

Certain operations described hereinabove in connection with FIGS. 2-7 are automatic operations that are built into the screen applications and thus are not dealt with by the protocol designers and thus do not appear as protocol elements in the workflow canvas user interface. An example of this is the “help is on the way” message that illustratively appears on a patient's bedside tablet after an owner has selected the “Notify” button (FIG. 7).

The overall request response protocol as shown in FIG. 12 is as follows, where the various tools in the protocol design space can also be understood as being “steps” in the protocol:

A patient makes a bathroom needs request by selecting the “Bathroom Needs” (1201) button on the main screen of her bedside tablet, per FIG. 2. The “unconditional ” connector connecting the “Bathroom Needs” tile to the “Assign Owner” tile means that responsive to the patient selecting the “Bathroom Needs” button on her bedside tablet screen, an owner for the request is automatically assigned (1202) by querying the staff management system (1203) for an appropriate owner to attend to the request based on an Assignment Chain that was defined by the protocol designer, per screen FIG. 16a described below. Once an initial owner has been successfully identified, that owner is notified of the assignment (1207)—illustratively both on a master device such as a tablet at a nurse's station, per FIGS. 6 and 7 and on the owner's individual mobile device. After the notification, the protocol proceeds to the wait state represented by the “Complete?” tool (1211). Meanwhile, after the owner is assigned, a timer is started (1209), with the timer's time frame being set by the protocol designer (as discussed below) for a time period within which it is expected that a “Bathroom Needs” request should have been completed by the assigned owner. Selection of the “Completed” button (FIG. 7) by the owner within the set time frame halts the timer. On the other hand, if the timer times out before the owner has selected the “Completed” button is taken to mean that the assigned owner will not be fulfilling the request and so another owner needs to be assigned. Thus a timing out of the timer is defined as a “failure” and the protocol designer has placed an on-failure connector leading from the “Timer” tool back to the “Assign Owner” tool so that another owner can be assigned and the timer is again started. This loop of events continues until an assigned owner indicates that the task has been completed.

Selection of the “Completed?” button (FIG. 7) by the owner also causes the protocol to proceed with two actions in parallel. Firstly, information about the completed task (“patient toileted at 11.46 AM”) gets reported into the electronic medical record system (1215), and a period of delay is invoked (1220). For some of the request response protocol's the protocol designer might also bring in a “Notify” tool and specify in the associated “tile property” screen a particular person to be notified that the task was completed. This wouldn't typically be the case for a request response protocol such as “Bathroom Needs” but in the case of a more medically significant request, such as inhalation therapy, it might be desired that upon the inhalation therapist indicating that the task was completed, the patient's assigned nurse is notified.

By the time “Report” tool is encountered in the course of the execution of a protocol, the request conveyance system is already in possession of all the information needed to make the report, the categories of information being specified by the protocol designer in a “tile properties” screen for the “Reports” tile. In some situations, there is no need to obtain any report information from the owner because the request conveyance system inherently has it. For example, all that may be required is the patient name, request owner, the fact that some service was provided, e.g., an inhalation therapy treatment, and the time the service was provided. Associated with the “Report” tool is information about the data input format for each electronic medical record system that the “Report” step may interface with at run time. Thus when the electronic medical record system is accessed at the “Report” step, the system knows how to interface with the electronic medical record system in order to get the reported information into the patient's record. Each other tool that interfaces with an external system similarly has information about how to access each of the different external systems that the request response protocol may be called upon to interact with.

Contrary to the situation described just above, the request conveyance system may not be in possession of all the information needed to make the report. Reporting the administration of a medication is an example. Before a medication report is entered in the electronic medical record system, the request response system will need to know what medication was administered and in what dose. In cases such as those, another tool such as “Medication Report” (not shown for this embodiment) would be brought into the protocol design space and connected in the protocol between the “Completed?” tile and the “Report” tile.

After the delay (1120), a survey is sent to the patient (1222) regarding, for example, the patient's view of how request was attended to, with questions and answers options for the survey having been specified by the protocol designer on an appropriate “tile property” screen that appeared during protocol creation. The patient's survey responses are tabulated and compared by the “Assess” tool (1224) to criteria defined by the protocol designer as to what constitutes a “success” what constitutes a “failure.” For example, as suggested earlier, the protocol designer might have indicated on the corresponding “tile property” screen that “success” means that the patient has checked the box “satisfied overall” presented in the survey whereas “failure” may mean that the patient answered at least one survey question with a “dissatisfied” indication.

On success, the care provider is notified (1125) and a report is written into the electronic medical records system (1228, 1231).

On failure, it is desired that the fact that the patient was unsatisfied with some aspect of her request be followed up on. To this end the protocol designer could augment the request response protocol by adding specific tools and connections onto the protocol design space.

In accordance with a feature of the invention, however, an entire patient response request protocol can itself be a protocol element. Thus in the present example of patient dissatisfaction with some aspect of her “Bathroom Needs” request, the protocol designer connected the non-arrowed end of an “on-failure” connector to the “Assess” tool; selected the “Patient Requests” tab of the protocol elements pane (as seen in FIG. 12) and then placed the “Report Problem” tile in the protocol design space and positioned it at the arrowed end of the on-failure connector. In this way, the “Report Problem” request is initiated automatically on behalf of the patient in just the way that the patient herself might have done so per FIG. 5.

Advantageously, then, a protocol designer can embed an entire request response protocol associated with a particular Patient Request into another request response protocol associated with another Patient Request (or, potentially, recursively into the protocol associated with that same Patient Request), rather than having to explicitly input the steps of the embedded protocol into the protocol being designed. This not only saves time and expense when a new protocol is being designed but also means that if a particular protocol is updated, all the protocols into which it has been embedded will automatically also be updated.

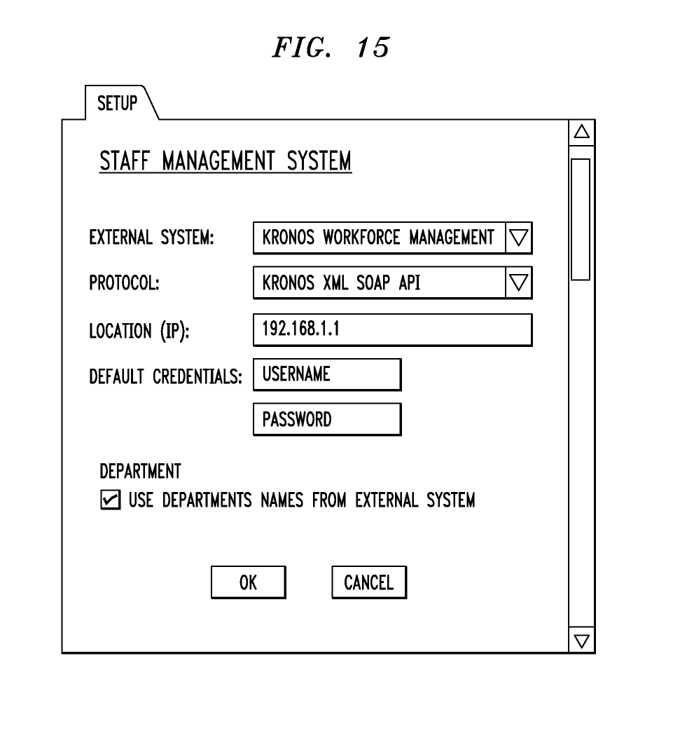

FIG. 13 shows the “Report Problem” request response protocol itself, which the protocol designer had already designed.

So more specifically then in the case of the “Bathroom Needs” protocol designed per the screens of FIGS. 8-12, suppose that the patient's bedpan has spilled. She can get help in illustratively one of two ways.

On the one hand, she can instantiate a “Report Problem” request by selecting the “Report Problem” button on her touch screen (FIG. 2) followed by the “Bathroom Needs problem” button on the subsequent screen (FIG. 5).

On the other hand, assume that what happened was that the patient had made a “Bathroom Needs” request by touching the “Bathroom Needs” button of FIG. 2. The assigned care provider had brought a bed pan to the patient and had then left the patient's room and now assume that the bed pan has spilled before anyone returned to the patient's room to empty it. At some point in time after the owner had indicated that the request had been completed, the patient is presented with a follow-up survey at step 1222 (FIG. 12) and because of the spill might provide an “unsatisfied” answer to a question in the survey because of the spill. The same “Report Problem” request that would have appeared on the care provider's device (FIG. 7) if the patient had explicitly selected the “Report Problem” and “Bathroom Needs Problems” buttons on her bedside tablet is now launched automatically (1227) from within the “Bathroom Needs” request response protocol.

As another example of the inclusion of a Patient Request within the request response protocol for another Patient Request, suppose that the hospital's routine is that a nurse is to bring a patient's medication but a nurse's aide is to bring water for the patient to take the medication. The same patient request that is instantiated when the patient simply wants some water might be included by the protocol designer as a protocol element in a “Medications” request response protocol. As a result, a request by a patient for her medication will cause the nurse to bring the medication and the nursing aide to bring the water.

FIG. 14 is a functional representation of illustrative hardware and software components that implement the workflow canvas and execute the patient request protocols. A request response system embodying the principles of the invention as described herein can be readily implemented by those skilled in the art and numerous various approaches for doing so will be readily apparent. The following illustrates one such straightforward approach.

The hardware and software that implement the workflow canvas include an editor user interface 171, an editor web service 172 and a protocol database 174. In particular, editor user interface 171 is a browser application that enables the protocol designer to create request response protocols, as exemplified in FIGS. 8-13. Editor user interface 171 is a graphic user interface (GUI) representation of the underlying editor web service 172.

Editor web service 172 includes the programming necessary to transform the graphical representations of the request response protocols into protocol models that are accessed by workflow engine 176 as described below to execute the protocols, and also provides an interface between editor user interface 171 and protocol database 174. Stored in the latter are a) the various protocol elements 174a manipulatable by the editor user interface, including information associated with the various tiles and the tool property screens, b) graphical representations of the request response protocols as designed by the protocol designer(s) 174b, including the components of the protocol, the location of the components within the protocol design space, etc. and c) models of the protocols 174c which contain all the information about the protocols that are needed by the workflow engine to actually execute the protocols. As a protocol is being designed—or, alternatively, all at once when the protocol designer has indicated that the protocol design is complete—the corresponding data model of the protocol is built based on data models for the various components that were included within the editor user interface at the time it was access through the protocol designer's browser. Also responsive to an input from the protocol designer, both the graphical representation of the request response and the data model thereof, get uploaded to the data center from the editor user interface web application and the editor web service 172 sees to the storage of same in protocol database 174. These can later be accessed via the editor user interface to be modified or edited.

The editor user interface, 171, editor web service 172 and protocol database 174 together make up that which has been referred to herein as the workflow canvas.

The hardware and software that execute the patient request protocols include patient/provider interface 173, engine web service 175, workflow engine 176, and, again, protocol database 174.

Patient/provider interface 173 is a browser application that present screens on the patient and provider devices. It corresponds to the the applications RC-B and RC-P described hereinabove in connection with FIG. 1. Patient/provider interface 173 communicates user inputs to the engine web service and receives, from the engine web service, information to be presented to the users. Engine web service 175 essentially mediates between the users (patients and providers) on the one hand, and workflow engine 176 on the other hand. When a user makes a request, workflow engine 176 is called upon via an engine web service 175 to access the appropriate one of protocol models 174c to pull out the defined steps, to access the external data systems as needed, and execute the relevant tasks to execute the protocol.

The editor user interface 171 and patient/provider interface 173 are illustratively implemented in JavaScript using the MooTools framework. The editor web service 172, engine web service 175, and Workflow engine 176 are illustratively implemented using the Zend Framework (a model view controller). The protocol elements 174a, graphical representations 174b and protocol models 174c are illustratively represented as JSON encoded strings that are used by the MooTools framework.

It was noted above that configuration inputs for a given instantiation of a tool in the protocol design space are illustratively input by the protocol designer by “right-clicking” on the tile in question and then inputting information into screens that pop up at that time. FIGS. 15 and 16a-c show examples of such “tile property” screens.

The screen shown in FIG. 15, for example, is brought up when the protocol designer right-clicks on an instantiation of the “Staff Management System” tile that has been placed into the protocol design space. The “External System” click-down menu lists all the commercially vended staff management systems to which the request conveyance system has been designed to communicate with. One of them is the Kronos Workforce Management system, as shown. It has been the one selected because, illustratively, that is the workforce management system used by the hospital for whom the request conveyance system is being administered. The protocol designer also indicates via the “Protocol” click-down menu which of the Kronos protocols is used by the hospital's instantiation of the Kronos system. Other input boxes accept a default IP address for the selected staff management system and a default username and password.

By checking the box “Use department names from external system,” the protocol designer can instruct the request conveyance system that department names as presented on various screens, e.g., that shown in FIG. 16a, should be those as used by the staff management system, e.g., “Nursing Assistants” instead of “Nursing Aides.”

Referring now to FIGS. 16a-c, the screens shown therein are the screens displayed when the protocol designer right-clicks on the “Assign Owner” tile and chooses one of the three tabs “Assignment”, “Options” and “Integration”. The protocol designer might first select the “Integration” tab, as shown in FIG. 16c. The “External System” click-down menu provided here will display only those systems for which information was entered on the “Staff Management System” screen of FIG. 15. As seen in FIG. 16c, the protocol designer has the option to specify an alternative protocol, username and password to the defaults that were previously entered. By selecting “Acquire staff mappings externally,” the protocol designer causes the request response protocol to access the selected External System—in this case the Kronos Workforce Management” system when identifying an owner for a given request. As an alternative, by selecting the “Use internal staff mappings” option, the protocol designer causes the request response protocol to access a staff database maintained within or for the request response system itself.

The protocol designer might then select the “Assignment” tab which, as shown in FIG. 16a, displays an Assignment Chain screen. This is where a sequence of owners and substitute owners are defined for the given request response protocol being created. In this example, the protocol designer has indicated that the owner might come from any of three departments, which causes three click-down menus to be displayed, designated as Department 1, Department 2 and Department 3. Click-down menus allow a particular department is chosen for each of Department 1, Department 2 and Department 3. In this case Nursing Assistants, Registered Nurses and Nurse Managers have been chosen. Within a department, the protocol designer can specify how many times the staff management system should be accessed in attempting to find an staff person to assign the request to. It is only after all the possibilities within Department 1 have been exhausted that the request may be conveyed to someone in the Department 2, and so forth.

More specifically, the protocol designer can specify how many owners are to be tried within a given department. In the case of Department 1 (Nursing Assistants) there are 3. By selecting “single owner” in a left-hand column of click-down boxes, the protocol designer then can click down on the corresponding right-hand box and choose from a list of staff designators, such as “Primary Department Member,” “Secondary Department Member,” “Alternative Primary Department Member,” and so forth. Within the staff management system (or internal staff list maintained by or for the request response system if that option was chosen in FIG. 16c, individual staffers within the various departments are associated with these designators. After an initial setup, these may be assigned automatically based on the known work schedules of the various staffers. Thus the designator “Primary Department Member” may be associated with D. Chen during the hours of 8 AM to 5 PM, Monday through Friday) and thus the reason that D. Chen was identified as the owner for the “Water” request of the example discussed above in connection with FIGS. 6 and 7 was that that request was, assumedly, made by a patient during those hours. A nurse manager, unit clerk, or other administrative staffer is illustratively empowered to change the designators via an appropriate web screen.

By having selecting “multiple owners” in the third line, the protocol designer will cause all members of the department to be concurrently assigned as owners if the Secondary Department Member proves unavailable. (When “multiple owners” is selected in a left-hand click-down, the legend “All Department Members” is displayed in the right-hand click-down box and the click-down arrow is disabled.) This is an option that, presumably, would be selected only for requests of a urgent nature, e.g. “Chest Pain” entered by a patient in a coronary care unit.

Certain options may be specified from the screen that is presented when the protocol designer selects the Options tab, as shown in FIG. 16b. As shown there, the protocol designer has selected the option “Remove previous ownership on ownership change” which means that when ownership of a given request changes, the request in question is removed from the previous owner's Active Requests list (FIG. 7). She has also selected the option “Jump to next department in chain if no active individuals are found. In various embodiments, “active” may mean that the staffer is known to be at work (by virtue of the staffer having logged in to the workforce management system) and/or the staffer has logged into her mobile device and/or that the staffer is within a certain proximity to the patient. Such proximity could be determined using the GPS capabilities of the mobile device if it and the system are set up for geo-location. Alternatively, a staffer's location could be determined from a real-time location service, provided by a third-party vendor, operated within the facility.

For some requests, it will be desired to go to staffers at, say, a higher level of job function but for others, perhaps not. She has left unselected the option “When assigning to ‘all members,’ assign to only active individuals.” In some cases, the fact that the staffer is not currently “active” may not be a reason not to make the assignment, e.g. e.g. the request owner is the hospital chaplain whose mobile device might be turned off but who is expected will be turning it on to check it on a periodic basis.

Not shown in the FIGS. are other “tile property” screens associated with other ones of the protocol elements that may be placed in the protocol design space. Those skilled in the art will readily understand how to develop “tile property” screens appropriate for the various protocol elements that may be designed for any given embodiment of the invention.

The foregoing merely illustrates the principles of the invention and many variations are possible.

For example, it was suggested above that identifying an owner might include determining whether a potential owner is within a certain proximity to the patient and that that might be determined from a real-time location service (RTLS), provided by a third-party vendor, operated within the facility. If the facility had such a service in operation, another workflow canvas tool could represent the invocation of that facility so that the protocol designer, after identifying from the workforce management system a particular staffer to be the owner, would be able to have the protocol access the RTLS and, if the identified staffer is not proximate to the patient, have the protocol identify a different staffer to be the owner.

Although the workflow canvas is shown and described principally in terms of the design of a new request response protocol, the description is equally applicable to the modification of an already-designed protocol. In that scenario, a protocol designer would bring up on the screen the graphical representation of the already designed protocol and could then change it in just the same way that the designer would change a protocol that was actually in the process of the being designed the first time around. Upon the designer completing the modifications, the corresponding updated graphical representation and protocol model would be uploaded by the editor user interface and stored in database 174.

It will thus be appreciated that those skilled in the art will be able to be able to devise numerous arrangements which, although not shown or described herein, embodying the principles of the invention and thus are within its spirit and scope.

1. A computer-implemented method for enabling a protocol designer to design a healthcare request response protocol, the method comprising
receiving from a user, via a graphical user interface presented to the user, inputs identifying tiles representing steps of a healthcare request response protocol being designed or modified and causing the identified tiles to be displayed in a protocol design space of the graphical user interface,
receiving from the user, via the graphical user interface, inputs identifying an execution sequence for the steps of the healthcare request response protocol and causing connections to be displayed in the protocol design space connecting the displayed tiles in accordance with the identified execution sequence for the steps, and
creating protocol models useable to control one or more computers to execute the designed healthcare request response protocol in response to receipt by at least one of the one or more computers of a request initiated by a healthcare patient.

2. The method of claim 1 wherein at least one of the tiles represents another healthcare request response protocol.

3. The method of claim 1 wherein at least one of the tiles represents an external computer system that is to be accessed during the execution of the healthcare request response protocol under design, the external computer system being of a type that is operable and accessible by users independent of the operation and access of the one or more computers controlled by the program code to execute the designed healthcare request response protocol.

4. The method of claim 3 wherein the at least one external system is one at least one a) a workforce management system, b) an electronic medical record system, c) a patient admission/discharge/transfer system, and d) a real-time location service.

5. The method of claim 1 wherein at least one of the inputs received from the protocol designer identifies, for a particular one of the steps, a first subsequent step to be performed when the particular one of the steps succeeded and a second subsequent step to be performed when the particular one of the steps failed.

6. One or more non-transitory tangible media having stored therein program code that, when executed by one or more processors, performs the steps of
receiving from a user, via a graphical user interface presented to the user, inputs identifying tiles representing steps of a healthcare request response protocol being designed or modified and causing the identified tiles to be displayed in a protocol design space of the graphical user interface,
receiving from the user, via the graphical user interface, inputs identifying an execution sequence for the steps of the healthcare request response protocol and causing connections to be displayed in the protocol design space connecting the displayed tiles in accordance with the identified execution sequence for the steps, and
creating protocol models useable to control one or more computers to execute the designed healthcare request response protocol in response to receipt by at least one of the one or more computers of a request initiated by a healthcare patient.

7. The media of claim 6 wherein the stored program code, when executed by one or more processors, performs the further step of
executing the designed healthcare request response protocol in response to the initiation of a request from a patient.

8. The media of claim 6 wherein at least one of the tiles represents an external computer system that is to be accessed during the execution of the healthcare request response protocol under design, the external computer system being of a type that is operable and accessible by users independent of the operation and access of the one or more computers controlled by the program code to execute the designed healthcare request response protocol.

9. The media of claim 6 wherein the at least one external system is one at least one a) a workforce management system, b) an electronic medical record system, c) a patient admission/discharge/transfer system and d) a real-time location service.

10. The media of claim 6 wherein at least one of the connections identifies, for a particular one of the steps, a first subsequent step to be performed when the particular one of the steps succeeded and wherein at least another one of the connections identifies, for said particular one of the steps, a second subsequent step to be performed when the particular one of the steps failed.
